(19) United States
(12) Patent Application Publication
(10) Pub. No.: US 2011/0119575 A1
(43) Pub. Date: May 19, 2011

(54) FIT-TO FUNCTION FOR DOCUMENT PROCESSING

(76) Inventor: Wesley W. Whitmyer, JR., Stamford, CT (US)

(21) Appl. No.: 12/979,604

(22) Filed: Dec. 28, 2010

(51) Int. Cl. G06F 17/00

(52) U.S. Cl. 715/252

(57) ABSTRACT

A fit-to function formats a word processing document to a fit-to page length by automatically adjusting document preference values. An algorithm is provided which specifies an order of adjusting document preference values as well as incremental adjustment values.

### FIELD OF THE INVENTION

The present teachings relate to document formatting and, more particularly, to automatically formatting word processor documents to certain size preferences.

### BACKGROUND OF THE INVENTION

Word processor software (the terms “software” and “services” are used interchangeably herein) is used to compose, edit, format, and print user-generated document content. Word processors have traditionally been distributed to end-users on compact discs or as downloadable programs. Users install a word processor onto a computer (e.g., PC, mobile device, etc.) in order to create and manipulate word processor documents.

Microsoft Word is one of the most widely used word processors. Microsoft Word provides for a number of document preferences which have default values but can be set by the user. Document preferences include margin sizes (e.g., top, bottom, right, left, etc.), header/footer size, paragraph spacing, and font sizing. These preferences provide the ability to format a document to different sizing requirements.

There are many other word processors available besides Microsoft Word, including WordPerfect and open source applications such as OpenOffice.org Writer, AbiWord, KWord, and LyX. Recently, web-based word processors (e.g., software-as-a-service, application service providers (ASPs), etc.) such as Google Docs, Zoho and others have gained momentum in the marketplace. As a result, there are now many different choices for a user looking for a word processor program, many of which may not be compatible with each other or support the same features (e.g., font type, etc.).

As users become increasingly mobile and use a number of different computing devices (e.g., personal computer, mobile device, web terminal, etc.), users have the need to use multiple word processors in their daily lives. For example, if a user creates a document with Microsoft Word on a computer at work, the user may then upload it to Google Docs in order to share it or to assure its availability for an upcoming trip away from the office. A document created (and initially formatted) in one word processor may have an undesirable format when imported into another word processor.

In addition, when a user creates a certain type of document, it may be preferable to automatically control certain preferences in order to format the document appropriately. For example, although not limited thereto, when a user creates a multi-page letter, it may be preferable for the document to adjust certain preferences so that the signature block is not left on a last page by itself. In this way, it may be preferable to automatically format the letter to fit a certain page length, although not limited thereto.

Therefore, it would be beneficial to have a superior system and method for automatically fitting a document to a certain size preference.

### SUMMARY OF THE INVENTION

The needs set forth herein as well as further and other needs and advantages are addressed by the present embodiments, which illustrate solutions and advantages described below.

The system of the present embodiment includes, but is not limited to: a computer; a database in electronic communication with the computer, the database having a plurality of document preference values that control document output characteristics; document content; document preparation software executing on the computer for generating the document with the document content; and fitting software executing on the computer for formatting the document according to one or more of the plurality of document preference values. One of the plurality of document preference values is a fit-to page length and the fitting software automatically adjusts one or more further document preferences to format the document to fit to the fit-to page length. The computer may comprise a plurality of computers in electronic communication with each other. The document content may be user-generated.

The method of the present embodiment includes the steps of, but is not limited to, providing a computer, providing a database in electronic communication with the computer, the database having a plurality of document preference values, receiving document content, providing document preparation software executing on the computer for creating a document with the document content, providing fitting software executing on the computer, and formatting the document with the fitting software by adjusting one or more document preferences. One of the plurality of document preference values is a fit-to page length and the fitting software automatically adjusts one or more further document preferences to format the document to fit to the fit-to page length. The computer may comprise a plurality of computers in electronic communication with each other and two of the plurality of computers may communicate with each other over the Internet.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is a block diagram depicting one embodiment of the system according to the present teachings;

FIG. 2 is a block diagram depicting one embodiment of the computer of FIG. 1;

FIG. 3 is a flow chart depicting one embodiment of the method according to the present teachings; and

FIG. 4 is a flow chart depicting one embodiment of the algorithm for formatting documents according to the present teachings.

### DETAILED DESCRIPTION OF THE INVENTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

The present teachings include, but are not limited to, a fit-to function for document preparation applications. In one embodiment, although not limited thereto, the document preparation application is a word processor (e.g., traditional software, web-based service, etc.). Accordingly, the fit-to function may be implemented in software executing on a computer readable medium and may be provided to run on a computer as a desktop application or as a web-based service, although not limited thereto. The fit-to function may automatically format a document based on one or more preferences to fit to a desirable size or other output characteristic, although not limited thereto.

The fit-to software may be an add-on feature or integrated into document preparation software. In one embodiment, although not limited thereto, the fit-to software may be initiated by a button on the document preparation software's toolbar. In this case, a user may provide a preferred number of pages, and then click the button, and the document will be fit to the preferred number of pages.

An office suite (e.g., productivity suite, etc.) is a collection of document preparation software used to create a number of different document types. The components of an office suite are generally distributed together with a consistent user interface and usually can interact with each other, sometimes in ways that an operating system would not normally allow. Document preparation software can be used to create a number of different document types including, for example, word processor documents, spreadsheets, and presentations. Word processors (including desktop publishing software, etc.) are perhaps the most ubiquitous component of an office suite because many people have the need to create word processing documents such as letters, reports, memoranda, contracts, correspondence, minutes, newsletters, resumes, schedules, invitations, purchase orders, and invoices, among others. For any type of document it may be preferable to format the document to fit to a desirable size and the present teachings are not limited to word processing documents.

Document preparation software may have preferences which include, although not limited thereto, values for margin sizes, header/footer sizes, paragraph spacing, document type, font size, line spacing, indention, and character spacing. Adjusting these preferences, either individually or in combination, allows a document to be formatted appropriately. For example, although not limited thereto, a document preference for fit-to page length may be provided and a document may be formatted to “fit to” that page length by adjusting one or more further document preferences. This may be preferable for multi-page documents, although not limited thereto, in order to format the document to a certain size.

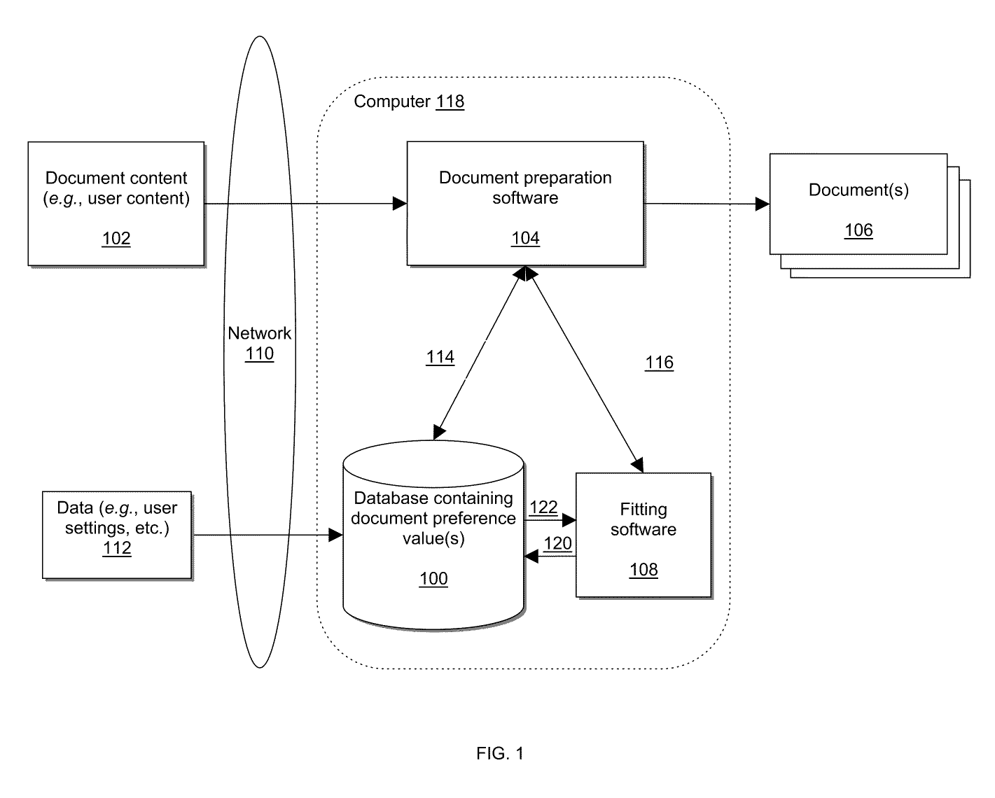

Referring now to FIG. 1, shown is a block diagram depicting one embodiment of the system according to the present teachings. A computer 118 may be provided to execute document preparation software 104 (and/or fitting software 108, discussed below, or any other software in the system) and/or store information (e.g., database 100, discussed further below), although not limited thereto. The computer 118 may be a single computer or a network of computers, although not limited thereto. Document preparation software 104 executing on the computer (e.g., on a computer readable medium, etc.) may be provided document content 102, which may include text for word processing documents, numbers for spreadsheets, images for presentations, or any combination thereof, although not limited thereto. The document content 102 may be user-generated, although not limited thereto. The document preparation software 104 may be made available over a network 110 such as the Internet, although not limited thereto. The document preparation software 104 may utilize the document content in order to create a document 106.

The document preparation software 104 may be in electronic communication with a database 100 which stores document preference values. The document preference values stored in the database 100 may include, although not limited thereto, values for document type (e.g., word processing document, spreadsheet, letter, memorandum, etc.), fit-to page length, margin sizes, header/footer sizes, paragraph spacing, document format, font size, line spacing, indention, and character spacing. These preference values, either alone or in combination, may be used to format the document 106 for output. Document values may be supplied by the user as user-settable settings 112 or as document preparation software 104 default values 114 or fitting software 108 default values 120, although not limited thereto. Values stored in the database 112 may be provided 122 to the fitting software 108.

In one embodiment, although not limited thereto, each document type may have default values for a number of different document types. For example, if a user wants to format a document type of memorandum, the memorandum document type may have default values for font, font size, margin sizes, and paragraph spacing, among others. In this way, setting the document type preference to “memorandum” may set a number of other document preference values. In another embodiment, document preference values may be user-definable when a document is formatted.

In a still further embodiment, although not limited thereto, a fit-to page length preference may calculate values for a number of other document preferences values in order to adjust the document format according to the page length preference, discussed further below.

Based upon document preferences, the document preparation software 104 may communicate with the fitting software 108 executing on the computer (e.g., on a computer readable medium, etc.) to format the document content 102 accordingly. The fitting software 108 may communicate with the document preparation software 104 for increased interoperability 116 between the software, although not limited thereto. Data may be exchanged 114, 116, 120, 122 by each of the elements of the system as desired, although not limited thereto. For example, in one embodiment the document preparation software 104 may include a fit-to button whereby a user provides a fit-to page length and after clicking the button the fitting software 108 automatically formats the document. As an example, the preference value of the fit-to page length preference may be set to two, so the fitting software 108 may adjust document preferences (e.g., font, font size, spacing, margins, etc.) in order to assure the document 106 fits to two pages, discussed further below. In one embodiment, the fitting software 108 may shrink down the document content 102 (using the document preferences) to fit to the preferred number of pages. In another embodiment, the fitting software 108 may expand the document content 102, although not limited thereto.

In one embodiment, although not limited thereto, document preferences may include minimums below which a document preference may not be adjusted. For example, it may be preferable that a letter is never fit to a size in such a way that the width of the letter's left margin is below 0.5 inches. In this case, the fitting software 108 may have to adjust other preferences in order to format the document 106 appropriately. Minimums may be set for any number of document preferences including font size, margin sizes, character spacing, and paragraph spacing, although not limited thereto. In another embodiment, preferences may have maximums above which a preference value may not be set.

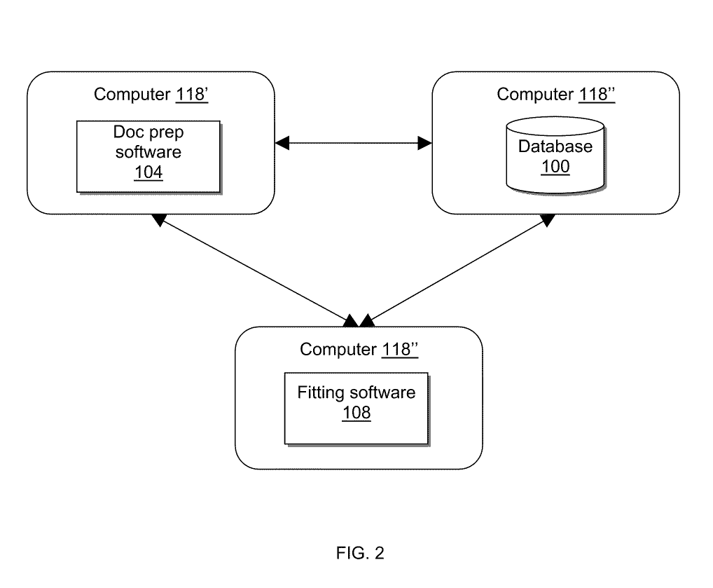

Referring now to FIG. 2, shown is a block diagram depicting one embodiment of the computer of FIG. 1. The computer 118 (shown in FIG. 1) may comprise a plurality of computers 118′, 118″, and 118′″, although not limited thereto. It is to be appreciated that a computer 118 or computers 118′, 118″, 118′″ may be provided to execute software 104, 108 or to store information 100, and the present teachings are limited to any particular configuration disclosed herein. In addition, computers 118′, 118″, 118′″, software 104, 108, and/or database 100 (shown in FIG. 1) may communicate with each other over a network 110 such as the Internet and the present teachings are similarly not limited to any network configuration disclosed herein. Each computer 118 or computers 118′, 118″, 118′″ may similarly comprise any number of processors and the present teachings are not limited to any particular embodiment disclosed herein.

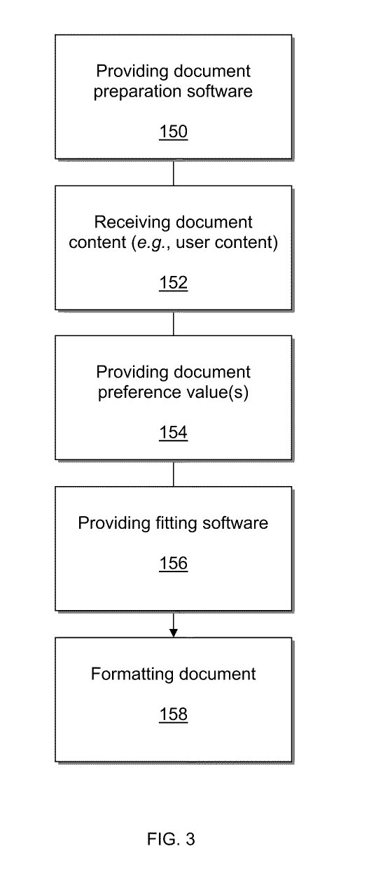

Referring now to FIG. 3, shown is a flow chart depicting one embodiment of the method according to the present teachings. A software/service provider may offer the fit-to functionality as an add-on service or integrated into some document preparation software, although not limited thereto. The method may therefore include the step of providing a computer and providing document preparation software 150. The document preparation software may execute on the computer as discussed above. The method may further include the step of receiving document content 152. The document content may be the content (e.g., text, numbers, etc.) used to create a document. The document content may be user-generated, although not limited thereto.

The method may also include the step of providing a document preference value 154. This may be provided by a user or as a default value by one of the pieces of software (e.g., document preparation software 150, fitting software 156, etc.), although not limited thereto. In addition, default values may be automatically set by another document preference such as document type, although not limited thereto. In this way, the document type may act like a template with default document preference values. The document preference value may be stored in a database and the step of providing a document preference value 154 may therefore comprise the step of providing a database. Document preferences may include document type, font, font size, margin sizes, and paragraph spacing, and character spacing, among others.

The method may further include the step of providing fitting software 156. The fitting software may execute on the computer as discussed above. Based upon one or more of the document preference values (e.g., fit-to page length, etc.), the fitting software may automatically format the document appropriately. Accordingly, the method may also include the step of formatting the document content 158 with the fitting software according to the document preference, although not limited thereto. In one embodiment, the document preference may be a fit-to page length.

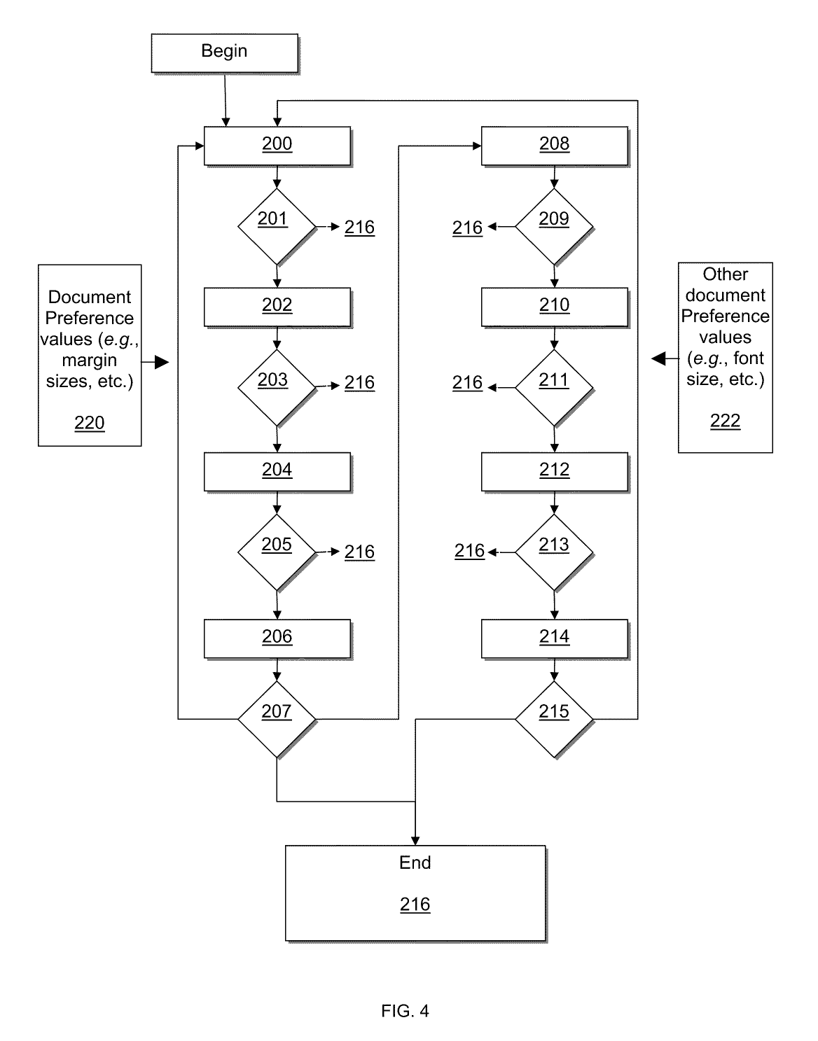

Referring now to FIG. 4, shown is a flow chart depicting one embodiment of the algorithm for formatting documents according to the present teachings. For example, if a fit-to page length preference value is set to two pages, it may be necessary to adjust document preferences 220, 222 such as font size, margin sizes, character spacing, and paragraph spacing, among others, in order to shrink the document content 102 (shown in FIG. 1) down to the preferred two page preference.

Preference values may be calculated according to an algorithm, although not limited thereto, which may provide an order in which to adjust each document preference as well as adjustment increments, although not limited thereto. This may be preferable so that the adjusted preference values are coordinated with each other. For example, it may not be preferable to adjust the left margin width to 0.1 inches while leaving the right margin width at an initial value of 2 inches, since this would make the formatted document look asymmetrical. Instead, by incrementally adjusting document preference values until the document is formatted appropriately, a more uniform distribution of document preference adjustments may be assured.

In one embodiment, it may be preferable to adjust each margin in 0.1 inch increments starting with the left margin 200, and then adjusting the top 202, right 204 and bottom 206 margins by the same increment. The fit-to page length (or other output characteristic) may be checked 210, 203, 205, 207 after each adjustment. If any adjustment formats the document to the preferable size, the algorithm may end 216. The adjustment of margin sizes may repeat one or more times (e.g., begin again with left margin 200, etc.) before adjusting another document preference.

If after adjusting each of the certain document preference values 220 (e.g., margins, etc.) a predetermined number of times (e.g., two) by a predetermined increment (e.g., 0.1 inch) the document is still not formatted to the correct size, the algorithm may adjust additional document preference values 222. For example, the algorithm may adjust paragraph spacing 208, font size 210, line spacing 212, and character spacing 214. This may be performed in predetermined increments as before: 3 point (paragraph spacing), 1 point (font size), 0.5 lines (line spacing), and 0.1 point (character spacing). It is to be appreciated that these incremental values are exemplary and the present teachings are not limited to any particular embodiment disclosed here.

Each document preference may have a predetermined minimum value (or maximum) below which the document preference value may not be adjusted. If the minimum (or maximum) is reached, the algorithm may just proceed to the next document preference value adjustment. If the document is formatted correctly after any adjustment, the algorithm may end 216. In the alternative, it may simply repeat itself until the desired formatting is achieved.

It is to be appreciated that any number of different document preference values may be adjusted in order to achieve the desired document size (or another document output characteristic) and the present teachings are not limited to the particular embodiment disclosed. Further, the algorithm may adjust document preference values in any order using any suitable incremental value. Each document preference value may also be set by the user, provided as default values (e.g., by the fitting software, etc.), or there may be default values for various document types (e.g., letter, memorandum, invoice, etc.), although not limited thereto. The algorithm provided herein is exemplary in nature and is not intended to limit the scope of the present teachings.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A fit-to function system for formatting a document, comprising:
a computer;
a database in electronic communication with the computer, the database having a plurality of document preference values that control document output characteristics;
document content;
document preparation software executing on the computer for generating the document with the document content; and
fitting software executing on the computer for formatting the document according to one or more of the plurality of document preference values;
wherein one of the plurality of document preference values is a fit-to page length; and
the fitting software automatically adjusts one or more further document preferences to format the document to fit to the fit-to page length.

2. The system of claim 1 wherein the computer comprises a plurality of computers in electronic communication with each other.

3. The system of claim 1 wherein the document preparation software is a word processor.

4. The system of claim 1 wherein the fitting software shrinks the document to fit to the fit-to page length.

5. The system of claim 1 wherein the fitting software enlarges the document to fit to the fit-to page length.

6. The system of claim 1 wherein one of the plurality of document preference values is set to a default value.

7. The system of claim 1 wherein one of the plurality of document preference values is set to a value provided by a user.

8. The system of claim 1 wherein the fitting software formats the document according to an algorithm which specifies an order of adjusting document preference values until the document is fit to the fit-to page length.

9. The system of claim 8 wherein the algorithm specifies incremental adjustment values for adjusting document preference values.

10. The system of claim 1 wherein one of the plurality of document preference values has a minimum value below which the fitting software may not set the document preference value.

11. The system of claim 1 wherein one of the plurality of document preference values has a maximum value above which the fitting software may not set the document preference value.

12. The system of claim 1 wherein the plurality of document preference values include at least one of: margin size, paragraph spacing, font size, line spacing, and character spacing.

13. A method of formatting documents, comprising the steps of:
providing a computer;
providing a database in electronic communication with the computer, the database having a plurality of document preference values;
receiving document content;
providing document preparation software executing on the computer for creating a document with the document content;
providing fitting software executing on the computer; and
formatting the document, with the fitting software, by adjusting one or more document preferences;
wherein one of the plurality of document preference values is a fit-to page length; and
the fitting software automatically adjusts one or more further document preferences to format the document to fit to the fit-to page length.

14. The method of claim 13 wherein the computer comprises a plurality of computers in electronic communication with each other.

15. The method of claim 14 wherein two of the plurality of computers communicate with each other over the Internet.

16. The method of claim 13 wherein the document preparation software is a word processor.

17. The method of claim 13 wherein the fitting software shrinks the document to fit to the fit-to page length.

18. The method of claim 13 wherein the fitting software enlarges the document to fit to the fit-to page length.

19. The method of claim 13 wherein the fitting software formats the document according to an algorithm which specifies an order of adjusting document preference values until the document is fit to the fit-to page length.

20. The method of claim 19 wherein the algorithm specifies incremental adjustment values for adjusting document preference values.

21. The method of claim 13 wherein one of the plurality of document preference values has a minimum value below which the fitting software may not set the document preference value.

22. The method of claim 13 wherein one of the plurality of document preference values has a maximum value above which the fitting software may not set the document preference value.

23. The method of claim 13 wherein the plurality of document preference values include at least one of: margin size, paragraph spacing, font size, line spacing, and character spacing.

24. A fit-to function system for formatting a document, comprising:
a computer;
a database in electronic communication with the computer, the database having a plurality of document preference values that control document output characteristics;
document content;
word processing software executing on the computer for generating the document with the document content; and
fitting software executing on the computer for formatting the document content according to one or more of the plurality of document preference values;
wherein one of the plurality of document preference values is a fit-to page length;
a user provides a fit-to value; and
the fitting software automatically adjusts two or more further document preferences to format the document to fit to the fit-to page length according to an algorithm which specifies an order of adjusting the two or more further document preference values until the document is fit to the fit-to page length as well incremental adjustment values for adjusting the two or more further document preference values.

25. The system of claim 24 wherein the computer comprises a plurality of computers in electronic communication with each other.

26. The system of claim 24 wherein the document content is generated by the user.
